(19) United States
(12) Patent Application Publication
(10) Pub. No.: US 2003/0118285 A1
(43) Pub. Date: Jun. 26, 2003

(54) Customizable chirped chiral fiber bragg grating

(76) Inventors: Victor Il?apos;ich Kopp, Flushing, NY (US); Azriel Zelig Genack, New York, NY (US)

Correspondence Address: Edward Etkin, Esq., Suite 3C, 4804 Bedford Avenue, Brooklyn, NY, 11235, US

(21) Appl. No.: 10/313,447

(22) Filed: Dec. 6, 2002

Related U.S. Application Data
(60) Provisional application No. 60/337,916, filed on Dec. 6, 2001.

(51) Int. Cl. G02B 6/34; G02B 6/26

(52) U.S. Cl. 385/37; 385/27; 385/15

(57) ABSTRACT

A chirped chiral fiber usable in dispersion compensators and other applications consists of a chiral fiber with a variable period along its length. Advantageously, the inventive chirped chiral fiber is customizable to any specific dispersion compensation application by selectively controlling the pitch along the fiber length. A chromatic dispersion compensator utilizing the inventive chirped chiral fiber and a circulator is also disclosed.

### CROSS REFERENCE TO RELATED APPLICATIONS

The present patent application claims priority from the commonly assigned U.S. provisional patent application Ser. No. 60/337,916 entitled “Customizable Chirped Chiral Fiber Bragg Grating” filed Dec. 6, 2001.

### FIELD OF THE INVENTION

The present invention relates generally to Bragg grating type structures, and more particularly to chirped fiber Bragg gratings implemented in a chiral fiber structure.

### BACKGROUND OF THE INVENTION

With the proliferation of fiber optic communication lines, the issue of chromatic dispersion has become an important consideration, especially for long fiber runs. It is well known that short pulses often used in high speed telecommunication lines have a large number of spectral components. Signals with different wavelengths propagate though the fiber optic medium at different velocities. This phenomenon is known as “chromatic dispersion”. As a result of dispersion, each pulse broadens in time over a long stretch of an optical fiber. The longer the fiber, the greater the distortion of the pulse. This change in pulse shape is undesirable in virtually all communication applications.

A number of solutions to this problem have been proposed over the years. The most successful solution involves placing a circulator flowed by a chirped fiber Bragg grating (FBG) at an end of a long fiber with a continuing fiber exiting the circulator. The chirped FBG has a varying period along its length such that the period increases as one moves away from the input side. This arrangement causes the slower spectral components to be reflected earlier upon entering the chirped FBG (and then rerouted by the circulator into the continuing fiber), while the faster spectral components travel further in the chirped FBG before being reflected and rerouted into the continuing fiber. Thus, the faster spectral components must travel a greater distance before joining the slower components, thereby restoring the pulse to its original shape.

However, the chirped FBG suffers from a number of drawbacks. FBGs are typically fabricated by irradiating a UV sensitive material with UV light through a pre-designed phase mask. The phase mask determines the periodicity and size of the resulting FBG and thus must be carefully designed to provide the desired chirping to an FBG. Because different optical fibers require chirped FBGs with different variations of the period and sizes to compensate for chromatic dispersion, a different phase mask must be designed for different optical fiber lines. Because of the complexity and expense in designing and fabricating phase masks, it is impractical to customize a chirped FBG for a specific optical fiber length. For example, a fiber that is 1250 kilometers long would need to use a chirped FBG designed for 1000 kilometers or 1500 kilometers, because it would be too cumbersome and expensive to design a new phase mask for this fiber length. Finally, due to the fact that chirped FBGs use UV-sensitive materials, the choice for materials is limited as well.

It would thus be desirable to provide an advantageous chirped FBG that is easy and inexpensive to manufacture and that may be readily customized for any desired application. It would also be desirable to provide a chirped FBG that could be made from any optical material.

### BRIEF DESCRIPTION OF THE DRAWINGS

FIG. 1 is a schematic diagram of a side view of an inventive chirped chiral fiber;

FIG. 2 is a schematic diagram of a first embodiment of the inventive chirped chiral fiber of FIG. 1 implemented in a chromatic dispersion compensator; and

FIG. 3 is a schematic diagram of an exemplary apparatus for fabricating and configuring the inventive chirped chiral fiber of FIG. 1 .

### SUMMARY OF THE INVENTION

The present invention is directed to a novel chirped chiral fiber Bragg grating (hereinafter “chirped chiral fiber”) that is based on a specially configured optical fiber structure having advantageous optical properties similar to a cholesteric liquid crystal (CLC) structure. The optical fiber structure used in the inventive chirped chiral fiber achieves optical properties similar to a CLC structure because it satisfies the requirement that in a CLC structure the pitch of the structure is twice its period. This is accomplished by using a chiral fiber structure having geometric birefringence with 180 degree symmetry. The desirable CLC optical properties may be obtained by imposing two identical coaxial helixes along a fiber structure, where the second helix is shifted by half of the structure's pitch forward from the first helix. Such structures are described in greater detail in the U.S. Patent applications entitled “Apparatus and Method for Manufacturing Fiber Gratings”, “Apparatus and Method of Manufacturing Helical Fiber Bragg Gratings”, “Apparatus and Method for Fabricating Helical Fiber Bragg Gratings”, and “Helical Fiber Bragg Grating” that are all hereby incorporated by reference herein in their entirety.

Essentially, the inventive chirped chiral fiber is similar in construction to a standard helical fiber Bragg grating disclosed in the above-incorporated patent applications, except that the inventive chirped chiral fiber has variable period along its length a smaller period in the first portion to immediately reflect slower signal pulse components having shorter wavelengths; gradually increasing to a larger period in its second portion to reflect faster signal pulse components having longer wavelengths.

An exemplary device for utilizing the inventive chirped chiral fiber—a chromatic dispersion compensator—is also disclosed. The chromatic dispersion compensator utilizes the inventive chirped chiral fiber and a circulator to restore a pulse having components that dispersed due to the length of a fiber that the pulse was traveling before arriving at the compensator.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The present invention is directed to an advantageous chirped chiral fiber that provides significant advantages over previously known chirped fiber Bragg gratings. Before describing the inventive chirped chiral fiber in greater detail, it would be advantageous to provide an explanation of the scientific principles behind chiral fibers. A chiral fiber is a novel structure that mimics the optical properties of a cholesteric liquid crystal (CLC)—the cholesteric periodic photonic band gap structure—in a fiber form. The above-incorporated U.S. patent application entitled “Helical Fiber Bragg Grating” (hereinafter “HFBG”)), disclosed the advantageous implementation of the essence of a cholesteric periodic photonic band gap (hereinafter “PBG”) structure in an optical fiber. This novel approach captured the superior optical properties of cholesteric liquid crystals while facilitating the manufacture of the structure as a continuous (and thus easier to implement) process.

In order to accomplish this, the HFBG patent application taught that the inventive structure must mimic the essence of a conventional CLC structure—its longitudinal symmetry. A helical fiber structure appears to have the desired properties. However, in a CLC structure the pitch is twice the period. This is distinct from the simplest realization of the helical structure, which is a single helix. In the single helix structure, the period is equal to the pitch and one might expect to find the band gap centered at the wavelength equal to twice the pitch. However, this arrangement produces a mismatch between the orientation of the electric field of light passing through the structure and the symmetry of the helix. The field becomes rotated by 360 degrees at a distance equal to the wavelength of light of twice the pitch. On the other hand, the helix rotation in this distance is 720 degrees. Thus, while a helical structure has certain beneficial applications it does not truly mimic the desirable CLC structure with one notable exception when the structure is composed of two different adjacent materials.

Thus, a structure that meets the requirements for producing a photonic stop band while preserving the advantages of a cholesteric structure must satisfy two requirements:

(1) that the period of the structure's optical dielectric susceptibility is half the desired wavelength, and

(2) the dielectric susceptibility of the structure rotates so that it is substantially aligned with the direction of the field of the circular polarized standing wave.

The HFBG patent application further taught that one of the most advantageous and simple ways to construct a structure satisfying these requirements is to create a double helix structure. In this structure, two identical coaxial helixes are imposed in or on a fiber structure, where the second helix is shifted by half of the pitch forward from the first helix. Another advantageous structure satisfying these requirements, is a single helix structure that is composed of two adjacent components of different optical indices joined together. In this case, the wavelength is equal to the pitch and the pitch is equal to twice the period of the effective optical dielectric susceptibility of the system. The HFBG patent application disclosed several embodiments of such advantageous double and single helix structures in optical fibers that may be fabricated as a matter of design choice. An advantageous apparatus and a method for fabricating double and single helix structures are disclosed in the above-incorporated U.S. Patent Application entitled “Apparatus and Method for Fabricating Helical Fiber Bragg Gratings”.

Essentially, the chirped chiral fiber of the present invention is an advantageously modified form of the chiral fiber disclosed in the HFBG patent—i.e. it is a chiral fiber having a varying period along its length. The inventive chirped chiral fiber maintains various optical properties of a CLC including, for example, polarization sensitivity. While the inventive chirped chiral fiber is described with reference to the above-incorporated embodiments of inventive optical fibers having CLC-like properties derived from their helical or double helical structures, it should be noted that the inventive chirped chiral fiber may be advantageously constructed utilizing any optical fiber having CLC-like optical properties regardless of how those properties are achieved. Furthermore, it should be noted that the various advantageous CLC-related techniques disclosed in the above-incorporated U.S. Patent Applications may be readily adapted to and advantageously utilized in conjunction with the inventive chirped chiral fiber as a matter of design choice.

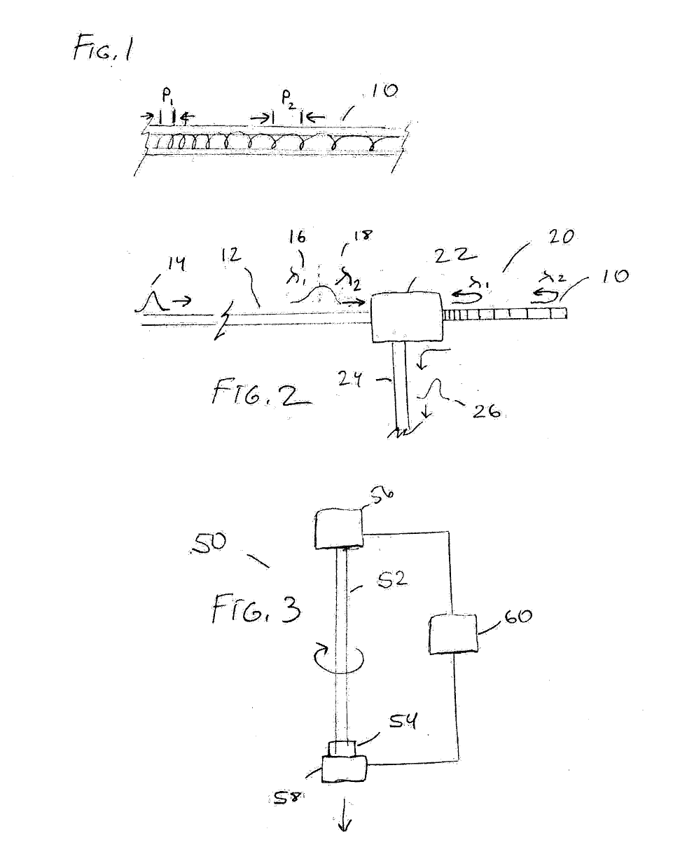

Referring to FIG. 1, an inventive chirped chiral fiber 10 is shown. The chirped chiral fiber 10 is configured to receive a signal with pulse components traveling at different speeds, and has a variable period along its length—a smaller period P₁ in the first portion to immediately reflect slower signal pulse components having shorter wavelengths; gradually increasing to a larger period in its second portion to reflect faster signal pulse components having longer wavelengths.

The chirped chiral fiber 10 can be advantageously utilized in a variety of applications as a matter of design choice. For example, it may be used in a chromatic dispersion compensator, a broadband rejection filter, or a sensor that locates a position of distortion in a long fiber run.

Referring now to FIG. 2, an exemplary chromatic dispersion compensator 20 is shown, consisting of a circulator 21 and 10 chirped chiral fiber 10. A pulse 14 spreads and becomes dispersed as it travels along a long optical fiber 12 and is separated into a slower component group 16 and a faster component group 18. While only two component groups 16, 18 are shown, it should be understood by one skilled in the art, that each component group is composed of a large number of individual pulse components or a continuum of such components, each of a particular wavelength and with a different speed of propagation. Both component groups 16, 18 pass through the circulator 22 and enter the chirped chiral fiber 10. The circulator 22 allows pulse component groups 16, 18 reflected from the chirped chiral fiber 10 to pass into a continuing fiber 24. As shown in FIG. 2, the inventive chirped chiral fiber 22 has variable period along its length—a smaller period P₁ in the first portion to immediately reflect the slower pulse component group 16 having shorter wavelengths, and a larger period P₂ in its second portion to reflect the faster pulse component group 18 having longer wavelengths. Thus, preferably, the chirped chiral fiber 10 is configured to provide reflections of each pulse component group 16, 18 in such a manner as to form the restored pulse 26.

While the basic functionality of the chirped chiral fiber 10 appears to mimic a standard chirped FBG, one of the essential points of the invention is in how the chirped chiral fiber 10 is configured during fabrication. The above-incorporated “Apparatus and Method for Fabricating Helical Fiber Bragg Gratings” U.S. patent application discloses a novel system and method of fabricating chiral fibers by heating a portion of an optical fiber with a non-cylindrical core and then twisting the fiber while drawing it—thus producing a chiral fiber with a uniform period.

Referring now to FIG. 3 a simplified diagram of an exemplary fabrication device 50 is shown. The fabrication device 50 comprises a retaining unit 56 for holding one end of an optical fiber workpiece 52, while a drawing unit 58 pulls the fiber workpiece 52 at the same time as a twisting unit 54 twists the fiber workpiece 52 around the fiber's longitudinal axis. When the drawing and twisting occurs at a stable predefined speed, an ordinary chiral fiber is produced. However, in accordance with the present invention, one or more of (a) the drawing speed of the drawing unit 58, (b) the acceleration of the drawing unit 58, (c) the twisting speed of the twisting unit 54, and (d) the acceleration of the twisting unit 54, may be selectively varied during the fabrication process to produce the chirped chiral fiber 10 with a variation in period governed by the variation in the drawing and/or twisting speeds and/or accelerations.

For example, increased drawing speed during a portion of the fabrication process, while the twisting speed is maintained, will produce an increased pitch (and thus an increased period) in one section of the chirped chiral fiber 10 fabricated from the fiber workpiece 52. Similarly, maintaining drawing speed while increasing the twisting speed will decrease the pitch and thus the period in a section of the chirped chiral fiber 10. These speeds may be controlled by a programmable computer system 60, and thus a variety of custom-made chirped chiral fibers may be easily produced for any application and from any optical fiber material. For example, a chirped chiral fiber may be easily fabricated for a custom fiber length by simply changing program instructions in the control computer 58. Previously it would have been necessary to design a special phase mask for each new application.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A chirped fiber Bragg grating comprising:
a chiral fiber of a predefined length, having a first end and a second end, and having a period that varies along said length.

2. The chirped fiber Bragg grating of claim 1, wherein said period increases from said first end to said second end.

3. A chromatic dispersion compensator for use with a first optical fiber carrying a signal pulse of a predefined shape having pulse components propagating at a plurality of velocities and thus subjected to dispersion of said predefined shape, and a second optical fiber, comprising:
a circulator having a first port, a second port, and a third port, operable to direct signals entering said first port to exit through said second port and to direct signals entering said second port to exit through said third port, wherein the first optical fiber is connected to said first port and said second optical fiber is connected to said third port; and
a chirped chiral fiber of a predefined length, having a first end connected to said second port and a second end, and having a variation in the period along said length, such that said period increases from said first end to said second end, said chirped chiral fiber being configured to reflect the plural pulse components into said second port in such a manner as to substantially restore the predefined shape of the signal pulse and eliminate the dispersion.

4. An apparatus for fabricating and configuring a chirped chiral fiber of a predetermined length from an optical fiber workpiece comprising:
configuration means for selectively changing a period of said chirped chiral fiber along said predetermined length during fabrication.

5. The apparatus of claim 4, wherein said configuration means comprise:
drawing means for drawing said workpiece at a predetermined drawing speed and acceleration;
twisting means for twisting said workpiece at a predetermined twisting speed acceleration; and
control means connected to said drawing and said twisting means for selectively varying at least one of said drawing and said twisting speeds and said drawing and said twisting accelerations to vary a pitch of the chirped chiral fiber along said predetermined length.

6. A method of fabricating and configuring a chirped chiral fiber of a predetermined length from an optical fiber workpiece comprising the step of:
(a) selectively changing a period of said chirped chiral fiber along said predetermined length during fabrication.

7. The method of claim 6, wherein said step (a) comprises the steps of:
(b) drawing said workpiece at a predetermined drawing speed and acceleration;
(c) twisting said workpiece at a predetermined twisting speed acceleration; and
(d) selectively varying at least one of said drawing and said twisting speeds and said drawing and said twisting accelerations to vary a pitch of the chirped chiral fiber along said predetermined length.
